(19) United States
(12) Patent Application Publication
(10) Pub. No.: US 2022/0396084 A1
(43) Pub. Date: Dec. 15, 2022

(54) UNIVERSAL HOLD DOWN PALLET SYSTEM

(71) Applicant: Action Engineering, Inc., Lilburn, GA (US)

(72) Inventors: Erik Alan Naftal, Tucker, GA (US); Brandon Danch-Powell, Stone Mountain, GA (US)

(21) Appl. No.: 17/807,053

(22) Filed: Jun. 15, 2022

Related U.S. Application Data
(60) Provisional application No. 63/210,632, filed on Jun. 15, 2021.

(51) Int. Cl. B41J 11/06; B41J 11/14; B41J 3/407; B41F 15/22

(52) U.S. Cl. CPC B41J 11/06; B41J 11/14; B41J 3/4078; B41F 15/22

(57) ABSTRACT

Various embodiments of a universal hold down pallet system for garment printing are described. In one example, a system includes a gasket plate comprising a plate having an opening and a gasket disposed at a perimeter of the opening, the opening sized and configured to mate with a pallet to hold a garment in place, and a head frame comprising at least one gasket plate guide channel positioned on a bottom surface of the head frame and a gasket plate latch assembly positioned at a first end section of the head frame, the at least one gasket plate guide configured to slidably receive the gasket plate. Where the gasket plate and the pallet are a set sized for a specified printing area, the set being one of a plurality of sets that are interchangeable in the universal hold down pallet system.

### CROSS REFERENCE TO RELATED APPLICATIONS

This application claims the benefit of and priority to U.S. Provisional Application No. 63/210,632, filed Jun. 15, 2021, titled “Universal Hold Down Pallet System,” the entire contents of which is hereby incorporated herein by reference.

### BACKGROUND

Screen printing and inkjet printing are used in the garment printing industry to create a custom design on a garment. Inkjet printing, also known as direct-to-garment (DTG) printing, is similar to printing paper on a desktop inkjet printer but uses a printer to spray the ink onto the fabric of the garment. Screen printing facilitates the application of one or more layers of ink on top of the fabric through a screen.

### BRIEF DESCRIPTION OF DRAWINGS

Many aspects of the present disclosure can be better understood with reference to the following drawings. The components in the drawings are not necessarily drawn to scale, with emphasis instead being placed upon clearly illustrating the principles of the disclosure. In the drawings, like reference numerals designate corresponding parts throughout the several views.

FIG. 1 illustrates a top perspective view of an example universal hold down pallet system in a closed position according to various embodiments described herein.

FIG. 2 illustrates a bottom perspective view of the example universal hold down pallet system shown in FIG. 1 according to various embodiments described herein.

FIG. 3 illustrates an example guide channel interference fit between a pallet and a pedestal arm in the system shown in FIGS. 1 and 2 according to various embodiments described herein.

FIG. 4 illustrates the universal hold down pallet system shown in FIGS. 1 and 2, in an open position, according to various embodiments described herein.

FIG. 5 illustrates a bottom view of the end of the head frame of the universal hold down pallet system shown in FIGS. 1 and 2 according to various embodiments described herein.

FIG. 6 illustrates a top view of the end of the head frame of the universal hold down pallet system shown in FIGS. 1 and 2 according to various embodiments described herein.

FIG. 7 illustrates an example of the head frame of the universal hold down pallet system shown in FIGS. 1 and 2 in an unlocked position with the gasket plate being removed according to various embodiments described herein.

FIG. 8 illustrates a top perspective view of another example universal hold down pallet system in a closed position according to various embodiments described herein.

FIG. 9 illustrates a bottom perspective view of the example universal hold down pallet system shown in FIG. 8 according to various embodiments described herein.

FIG. 10 illustrates the universal hold down pallet system shown in FIGS. 8 and 9, in an open position according to various embodiments described herein.

FIG. 11 illustrates the universal hold down pallet system shown in FIGS. 8 and 9, in an open position with a pallet according to various embodiments described herein.

FIG. 12 illustrates the universal hold down pallet system shown in FIGS. 8 and 9 with a pallet installed according to various embodiments described herein.

FIG. 13 illustrates an end of an example gasket plate that can be used with the system shown in FIGS. 8 and 9 according to various embodiments described herein.

FIG. 14 illustrates a top view of an example gasket plate that can be used with the system shown in FIGS. 8 and 9 according to various embodiments described herein.

FIG. 15 illustrates another example gasket plate and head frame that can be used with the universal hold down pallet systems according to various embodiments described herein.

FIG. 16 illustrates the gasket plate and head frame shown in FIG. 15, with magnets for interlocking, that can be used with the universal hold down pallet systems according to various embodiments described herein.

### DETAILED DESCRIPTION

The process of printing on a garment can be accomplished using inkjet technology or screen printing, among other techniques. A variety of different types of printing machines for garments are known in the industry. To keep a garment from moving during the printing process, many screen printing machines include a jig or fixture, including a pallet or platen. In an example, one way of securing a garment to a pallet during multi-color printing is to use adhesive on the pallet surface. While an adhesive can be used to secure a single-ply garment in place for screen printing, it is not effective for multi-layer garments, particularly when printing requires exact multi-color registration. For example, if only one layer is secured to the pallet, one or more layers may move during the printing process. For inkjet printing, also known as direct-to-garment (DTG) printing, the use of adhesive is not advisable because the adhesive can clog the printing heads, rendering the machine unusable.

In the context outlined above, various embodiments of a universal hold down pallet system are described herein. The universal hold down pallet system can be used for either screen printing or DTG printing, but it is not limited to use with any particular types of printing processes or machines. The universal hold down pallet system can secure a garment in position between a head frame and a pallet, such that the printing area of the garment is held flat against the pallet. As examples, the garment can be a single-ply material, such as a t-shirt or sweatshirt, or a multi-layer garment, such as nylon jackets, reversible mesh jerseys, shorts, and the like. While a garment is used as an example, the universal hold down pallet system can be relied on to print on any fabric. For example, the universal hold down pallet system can be used to secure bags or other items with a printable surface.

According to aspects of the embodiments, the universal hold down pallet systems described herein include an interchangeable gasket plate configured to mate with a pallet having a specified printing area. For example, different sizes of pallets are often used for printing on different sizes of shirts, in order to maximize the available printing area of the shirt and also maintain the position of the shirt. A small shirt, for example, can be stretched if it is loaded onto a large pallet. Stretching deforms the garment and can deform the printed image. Although a large shirt can be loaded onto a small shirt pallet, the available printing area will be restricted to the smaller size.

Some printing machines require changing the pallet assembly for a different size or style of garment. Pallet changeovers require the operator to disengage the pallet assembly from the pedestal and lift the entire assembly off of the printing machine, and tools can be required to change the pallet assembly. Thus, pallet changing is cumbersome, and the pallets can be relatively heavy. The universal hold down pallet systems described herein simplify the process by permitting the use of interchangeable pallets and gasket plates. The interchangeable pallets and gasket plates can be changed while the head frame remains attached to the printing machine. Each pallet can be quickly removed and replaced from the printing machine. Similarly, each interchangeable gasket plate can be quickly removed and replaced from the head frame assembly. The pallets can include print surfaces of different sizes, and the gasket plates can include print windows of different sizes. The range of interchangeable pallets and gasket plates, which can be easily changed in the systems described herein, facilitate increased throughput for printing operations, avoid cumbersome pallet changeovers, and provide other benefits.

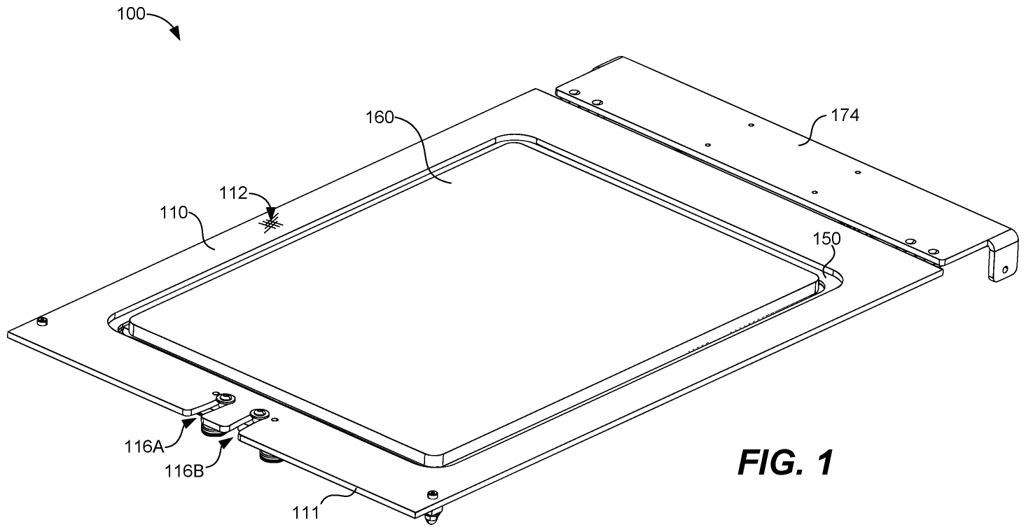

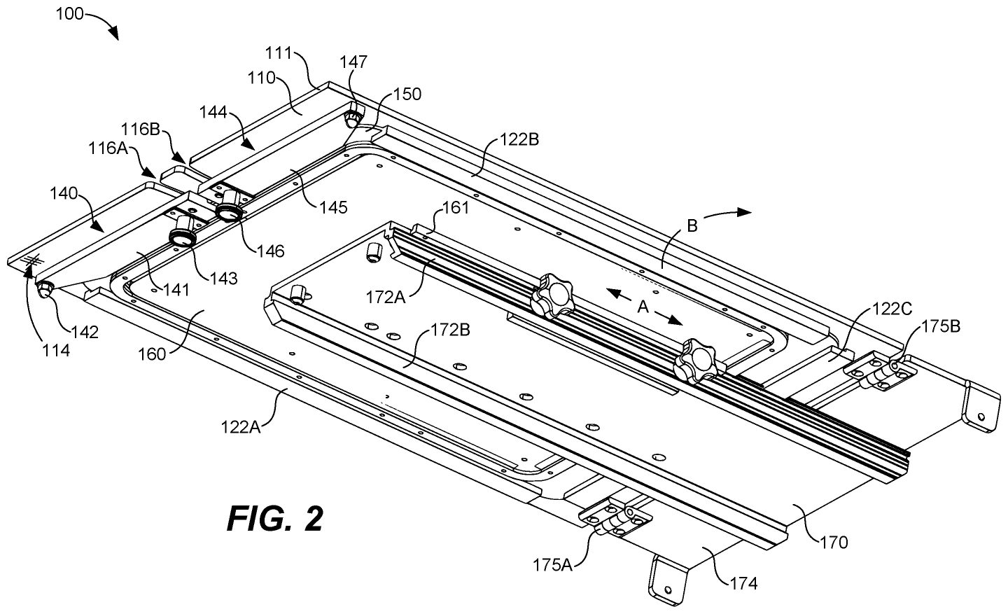

Turning to the drawings, FIG. 1 illustrates a top perspective view of an example universal hold down pallet system 100 (“system 100”) in a closed position, and FIG. 2 illustrates a bottom perspective view of the system 100 shown in FIG. 1 according to various embodiments described herein. The system 100 is illustrated as a representative example in FIGS. 1 and 2. The illustrations are not drawn to any particular scale, and the sizes and shapes of the components of the system 100, as described below, can vary as compared to that shown. The illustrations are not exhaustive, and other parts or components can be included and relied upon in some cases. Additionally, one or more of the parts or components shown can be omitted in some cases. The system 200 can be formed or embodied in any suitable materials, including metals, plastics, rubbers, etc., and combinations thereof. As one example, system 100 can be formed from a combination of aluminum, plastic, and rubber, although other suitable materials can be relied upon.

Referring between FIGS. 1 and 2, the universal hold down pallet system 100 includes a head frame 110, a gasket plate 150, a pallet 160, a pallet mount arm 170, a head frame mount 174, and a hinge assembly including hinges 175A and 175B, among other components. In the example shown, the pallet mount arm 170 acts as a supporting platform for the pallet 160, the head frame mount 174, and the head frame 110. The pallet mount arm 170 can be secured to a variety of different types of printing machines for garments. In some cases, the pallet mount arm 170 can be mounted to another pedestal or mount of a printing machine, to secure the system 100 in place.

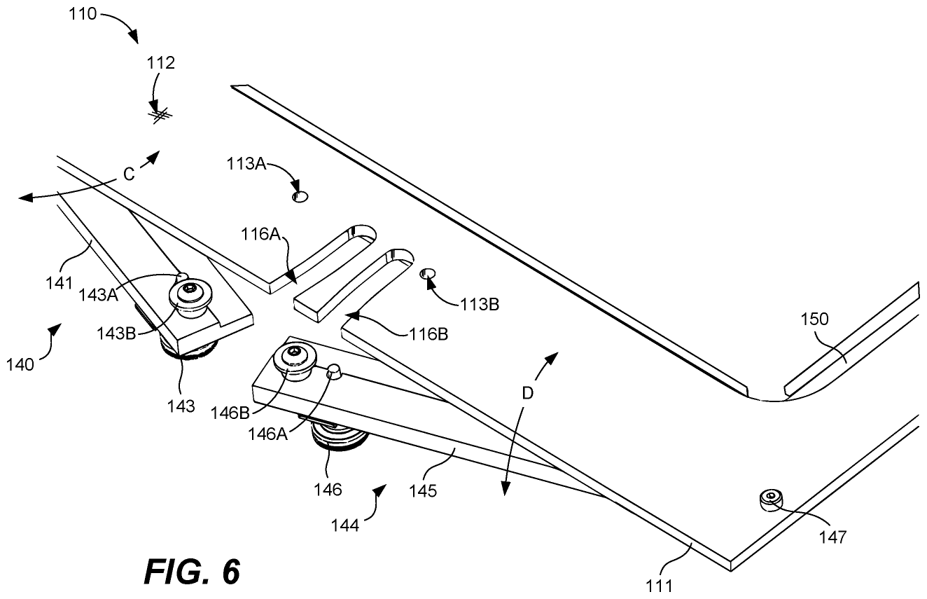

The head frame 110 includes a top surface 112, a bottom surface 114, a frame opening 120 (see FIG. 6), guide channels 122A and 122B secured to the bottom surface 114 of the head frame 110, a backstop channel 122C secured to the bottom surface 114 of the head frame 110, first and second pivoting gasket arms 140 and 144, and gasket arm guide slots 116A and 116B. The first pivoting gasket arm 140 includes an arm 141, a pivot 142 with the head frame 110 at one end of the arm 141, and a spring plunger 143 at another end of the arm 141. The second pivoting gasket arm 144 includes an arm 145, a pivot 147 with the head frame 110 at one end of the arm 145, and a spring plunger 146 at another end of the arm 145.

The pallet 160 can be removably mounted to the pallet mount arm 170, so that the pallet 160 is interchangeable for the system 100. As described herein, both the gasket plate 150 and the pallet 160 are interchangeable, providing flexibility for operators. For example, to adapt a printing machine for use with a pallet having a different size, the system 100 allows an operator to interchange the pallet 160 and the gasket plate 150, without any need to remove the head frame 110 or other components from the printing machine.

As examples, an operator can exchange the pallet 160 with a different pallet having top surface dimensions of 4″×18″ for sleeve printing, 7.5″×7.5″ for athletic shorts, 12″ x 16″ for youth-large jackets, or 16″×16″ for large or extra-large jackets. The use of other pallets with other top surface dimensions, shapes, and styles are also within the scope of the embodiments. The operator can also change the gasket plate 150 by sliding it out from the head frame 110 and replacing it with a different gasket plate having a print window of a different size, to correspond to the different pallet being used, as described herein. Overall, the system 100 is not limited to the use of pallets of any particular size, shape, or configuration. Instead, the system 100 is designed to be flexible and capable of use with pallets of nearly any size and shape.

The pallet 160 can be removably mounted to the pallet mount arm 170 using a number of different techniques, with a preference for techniques that permit easy removal of the pallet 160 from the pallet mount arm 170. Referring to the example shown in FIG. 2, the pallet 160 includes a pair of guide channels, including the guide channel 161 and a second guide channel that is obscured from view (i.e., not shown in FIG. 2) by the pallet mount arm 170. The guide channel 161 can be secured to the bottom surface of the pallet 160 using screws or other suitable mechanical fasteners, and the second guide channel can be secured to the bottom surface of the pallet 160 in a similar way. The pallet mount arm 170 also includes supporting railways 172A and 172B, which extend down along the peripheral side edges of the pallet mount arm 170. The guide channels of the pallet 160, including the guide channel 161, can slide into rail slots at a top end of the supporting railways 172A and 172B, to secure the pallet 160 with the pallet mount arm 170. The pallet 160 can slide in the direction “A” shown in FIG. 2, for placement and removal of the pallet 160 onto the pallet mount arm 170.

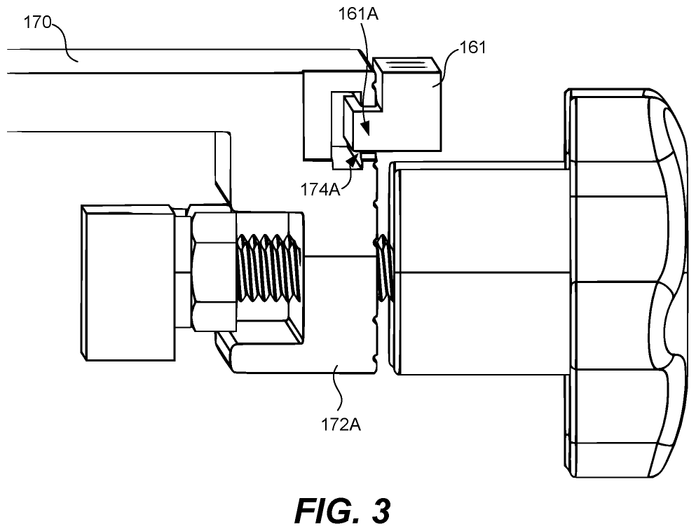

FIG. 3 illustrates an example guide channel interference fit between the pallet 160 and the pallet mount arm 170 in the system 100. In FIG. 3, the guide channel 161 of the pallet 160 is shown, along with the pallet mount arm 170 and supporting railway 172A of the pallet mount arm 170. The pallet 160 is omitted from view for simplicity. The guide channel 161 has an “L” profile. With the “L” profile, a clearance exists between a bottom surface of the pallet 160 and the interlocking tooth 161A of the guide channel 161. The interlocking tooth 161A of the guide channel 161 can slide into a rail slot 174A formed at a top end of the supporting railway 172A as shown in FIG. 3.

Along with the second guide channel of the pallet 160, which also slides into a similar rail slot at the top end of the supporting railway 172B, the pallet 160 can be slid onto and secured over the pallet mount arm 170. In some cases, the pallet mount arm 170 can also include an interference stop or other means to prevent the pallet 160 from sliding too far down the supporting railways 172A and 172B (see FIG. 2) towards the head frame mount 174, but the interference stop is not needed in all cases. In other examples, the guide channels of the pallet 160 can include a stop or closed end (i.e., a closed end of the “L” profile) at one end (i.e., the end closest to the leading edge 111 of the head frame 110), to prevent the pallet 160 from sliding too far down the supporting railways 172A and 172B. The positions at which the guide channels are secured to the bottom of the pallet 160 can also be selected to direct the extent to which the pallet 160 will slide along the supporting railways 172A and 172B. Other approaches can be relied upon to secure the pallet 160, among others, with the pallet mount arm 170 or other supporting structures, as described below.

Referring back to FIG. 2, the head frame mount 174 is also secured to the top surface of the pallet mount arm 170. The head frame mount 174 can be secured to the pallet mount arm 170 using any suitable mechanical or other fastening means, such as screws, bolts, welds, rivets, mechanical interferences, combinations thereof, or other means. In some cases, a mounting offset or interposer of a certain thickness can be inserted between the head frame mount 174 and the pallet mount arm 170, to ensure that the top surface of the pallet 160 is substantially coplanar with the top surface 112 of the head frame 110 when the head frame 110 is closed as shown in FIG. 1.

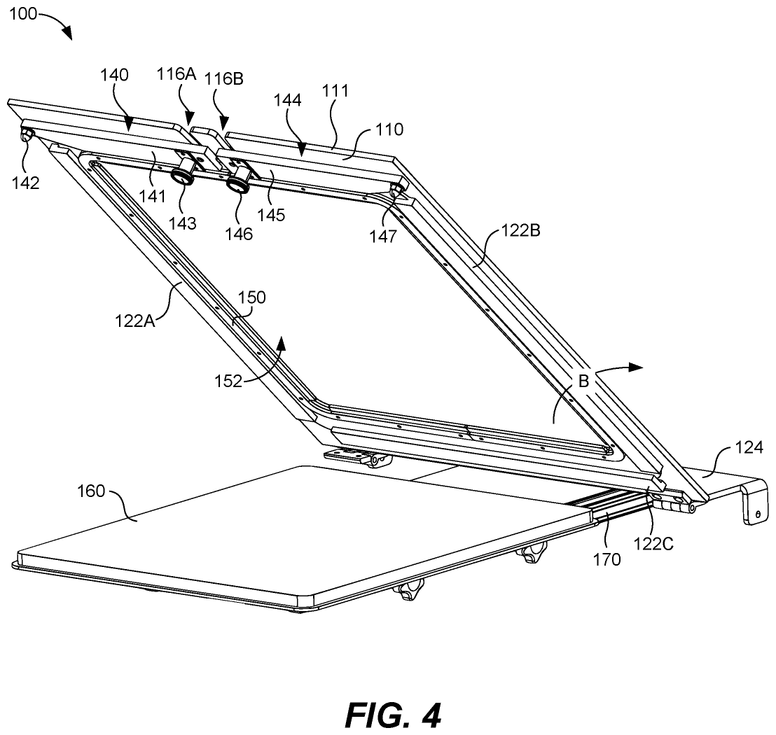

The head frame 110 is pivotably secured to the head frame mount 174 by a hinge assembly including the hinges 175A and 175B. The hinges 175A and 175B are illustrated as a representative example in FIG. 2, and other types of hinges and pivoting assemblies can be used to secure the trailing edge or end of the head frame 110 to the leading edge or end of the head frame mount 174. In this hinged arrangement, the leading edge 111 of the head frame 110 can pivot and rotate up in the direction “B”, as shown in FIG. 2, to pivot the head frame 110 up and apart from the pallet 160. FIG. 4 illustrates an example of the system 100 with the head frame 110 pivoted to an open position with respect to the pallet 160, and FIG. 4 is described in additional detail below.

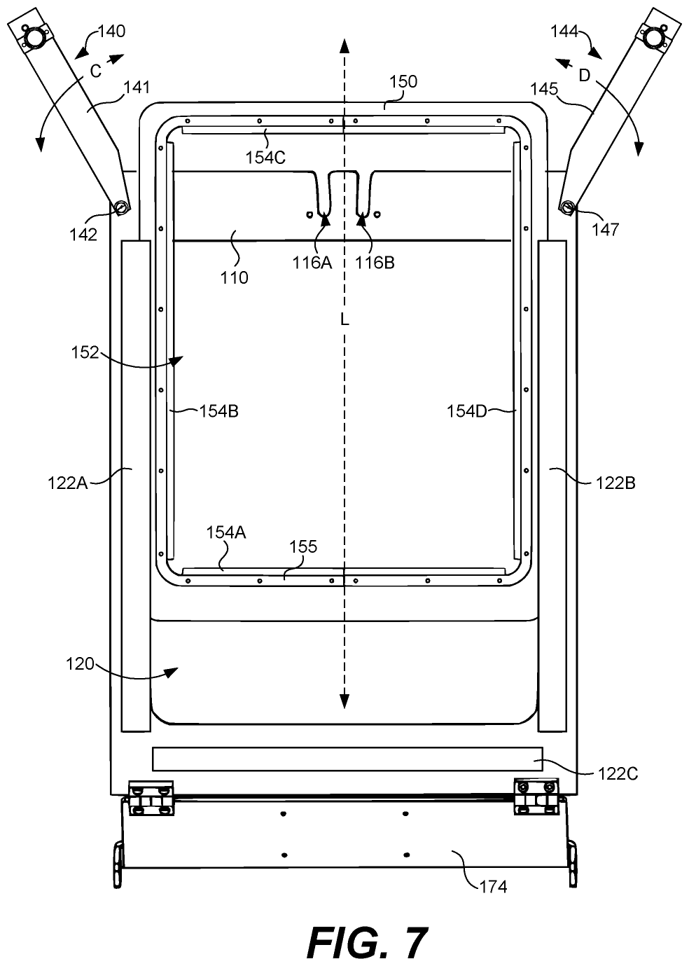

Referring again to FIG. 2, the gasket plate 150 is secured within the head frame 110 between the guide channels 122A and 122B and the backstop channel 122C. Each of the guide channels 122A and 122B and the backstop channel 122C is formed to have an “L” shape profile. When secured to the bottom surface 114 of the head frame 110, a clearance exists between the channels 122A, 122B and 122C and the bottom surface 114 of the head frame 110. The gasket plate 150 is relatively thin (or relatively thin at its outer peripheral edges) and can slide into this clearance. Particularly, when the first and second pivoting gasket arms 140 and 144 are rotated into an open position (see FIG. 7), the gasket plate 150 can be positioned and slid into the clearance at a location close to the leading edge 111 of the head frame 110. The gasket plate 150 will slide into the clearance, confined between the channels 122A and 122B and the bottom surface 114 of the head frame 110, until it contacts and stops against the backstop channel 122C. The first and second pivoting gasket arms 140 and 144 can then be rotated into the closed position illustrated in FIG. 2. The gasket plate 150 is easily removable and interchangeable in the system 100, as is the pallet 160. Additional details related to the insertion, removal, and replacement of the gasket plate 150 in the system 100 are described below with reference to FIGS.

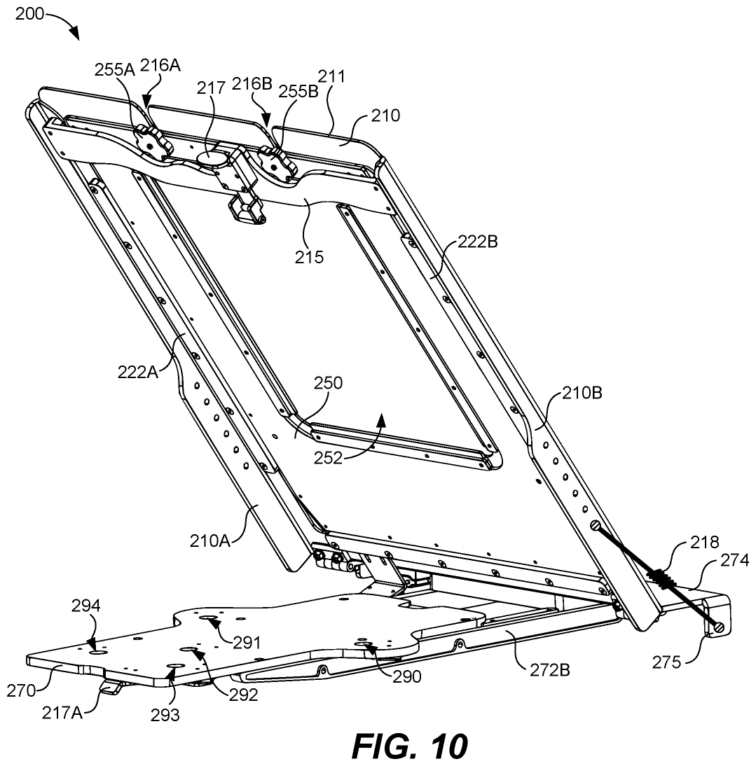

FIG. 4 illustrates the system 100 shown in FIGS. 1 and 2, with the head frame 110 pivoted to an open position with respect to the pallet 160. In this position, a garment can be placed over the pallet 160. The head frame 110 can be biased or maintained in the open position shown in FIG. 4 using a spring, elastic band, or other biasing means secured between the sides of the head frame 110 and the head frame mount 174, for example. The biasing means can be sufficient to maintain the head frame 110 in the open position shown, against the weight of the head frame 110, unless pushed back down to the closed position shown in FIG. 1. An example of such a biasing system is described below with reference to FIG. 10 and can be incorporated into the system 100.

To print on a garment, such as a shirt, the shirt can be placed over the pallet 160, with the pallet 160 positioned as the torso of an individual would fit into the shirt, as one example. Once the shirt is positioned over the pallet 160, the head frame 110 can be pivoted back down to the closed position shown in FIGS. 1 and 2. In that way, the head frame 110 will help to hold and secure the shirt against the pallet 160. Particularly, the gasket plate 150 includes a print window 152, as shown in FIG. 4. The print window 152 is sized such that, when the head frame 110 is closed, the print window 152 surrounds the peripheral edge of the pallet 160, with a relatively small clearance between them. The clearance can range, for example, from about ⅛″ to ½″, although other clearances can be relied upon. As examples, the print window 152 of the gasket plate 150 can be sized for 4″×18″, 7.5″×7.5″, 12″×16″, 16″×16″, or other top surface areas of the pallet 160 and other pallets, with additional room for a clearance around the peripheral edges the pallets as needed. In any case, a range of different gasket plates having print windows of various sizes, with corresponding pallets having top surface regions of various sizes, can be used with the system 100.

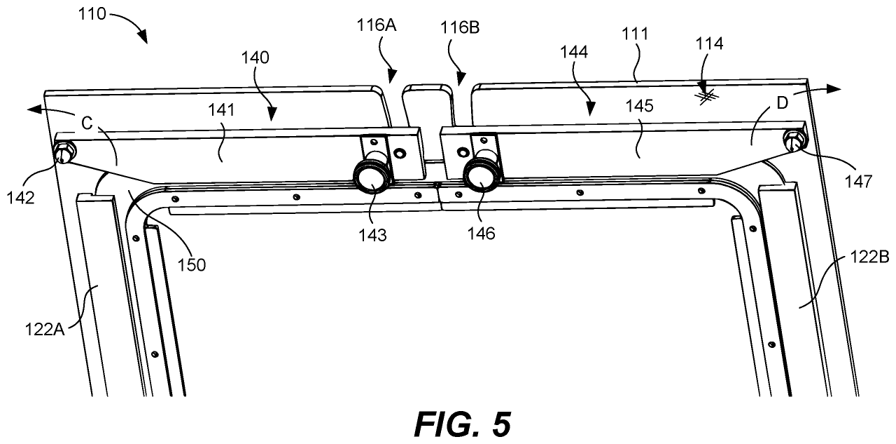

Turning to other aspects of the embodiments, FIG. 5 illustrates a bottom view of the end of the head frame 110 of the system 100, and FIG. 6 illustrates a top view of the end of the head frame 110 of the system 100. The first and second pivoting gasket arms 140 and 144 are shown in FIG. 5, and both are pivotably mounted at the bottom surface 114 of the head frame 110. The pivoting gasket arms 140 and 144 operate as doors, gates, or other mechanical interferences, which can be opened or closed, to permit removal and replacement of the gasket plate 150 when the arms 140 and 144 are open (see FIG. 7) or secure and prevent movement or replacement of the gasket plate 150 when the arms 140 and 144 are closed. Thus, the pivoting gasket arms 140 and 144 are provided as one example of a releasable interlock capable of securing and releasing a gasket plate from a head frame according to the embodiments.

Referring to FIG. 6, the head frame 110 includes the gasket arm guide slots 116A and 116B, which extend from the leading edge 111 of the head frame 110 to a distance into the head frame 110. As also shown in FIG. 6, the first pivoting gasket arm 140 includes a guide post 143B positioned toward one end of the arm 141. Similarly, the second pivoting gasket arm 145 includes a guide post 146B positioned toward one end of the arm 145. The gasket arm guide slots 116A and 116B extend about 1-3″ from the leading edge 111 of the head frame 110 into the head frame 110. The gasket arm guide slots 116A and 116B can be curved slightly as shown in FIG. 6, to track the arc of the guide posts 143B and 146B, respectively, as the first and second pivoting gasket arms 140 and 144 pivot in the directions “C” and “D” shown in FIGS. 5 and 6.

When the gasket arm 140 is closed, as shown in FIG. 5, the guide post 143B has rotated through the gasket arm guide slot 116A. In the fully closed position, the guide post 143B slides to and contacts the rounded, closed end of the gasket arm guide slot 116A. To secure the pivoting gasket arm 140 in that position, a spring-biased pin 143A (see FIG. 6) of the spring plunger 143 can snap up and seat into the locking aperture 113A in the head frame 110. In that way, the gasket arm 140 can be locked into position by a mechanical interference between the pin 143A of the spring plunger 143 and the locking aperture 113A. The gasket arm 140 can be unlocked, and rotated opened, by pulling down on the spring plunger 143, which will remove (i.e., drop or lower) the pin 143A out from the locking aperture 113A, permitting the gasket arm 140 to freely rotate around the pivot 142 with the head frame 110.

Similarly, when the gasket arm 144 is closed, as shown in FIG. 5, the guide post 146B has rotated through the gasket arm guide slot 116B. In the fully closed position, the guide post 146B slides to and contacts the rounded, closed end of the gasket arm guide slot 116B. To secure the pivoting gasket arm 140 in that position, a spring-biased pin 146A (see FIG. 6) of the spring plunger 146 can snap up and seat into the locking aperture 113B in the head frame 110. In that way, the gasket arm 145 can be locked into position by a mechanical interference between the pin 146A of the spring plunger 146 and the locking aperture 113B. The gasket arm 145 can be unlocked, and rotated opened, by pulling down on the spring plunger 146, which will remove (i.e., drop or lower) the pin 146A out from the locking aperture 113B.

The profiles of the arms 141 and 145 are similar to that of the guide channels 122A and 122B and the backstop channel 122C. That is, the arms 141 and 145 have an “L” shape profile. Thus, when the gasket arms 140 and 145 are closed, a clearance exists between the arms 141 and arm 145 and the bottom surface 114 of the head frame 110. An edge of the gasket plate 150 can thus fit under a region of the gasket arms 140 and 145 when closed, as shown in FIG. 5, to help secure the gasket plate 150 in place.

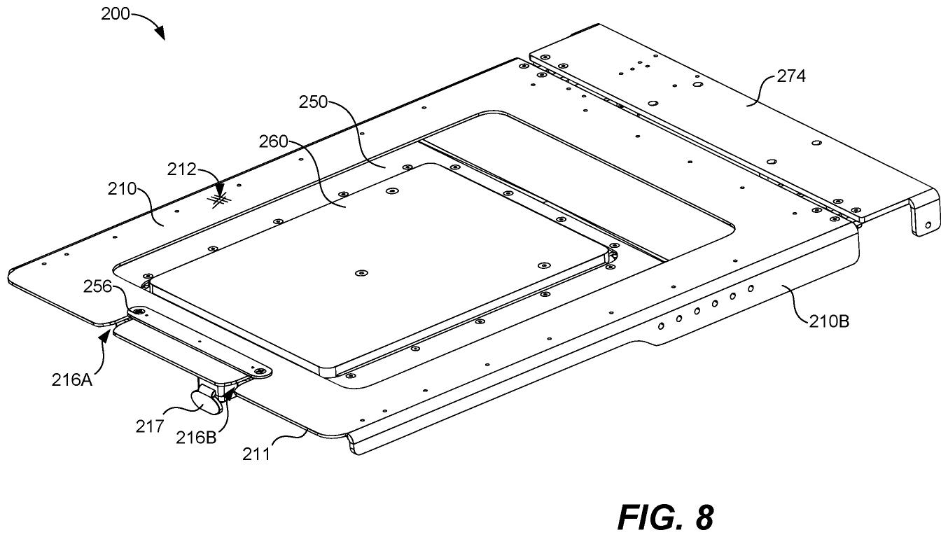

FIG. 7 illustrates an example of the head frame 110 of the system 100 in an unlocked position with the gasket plate 150 being removed. The separate frame opening 120 of the head frame 110 and the print window 152 of the gasket plate 150 are both shown in FIG. 7. The gasket arms 140 and 145 are rotated open in FIG. 7. In that open configuration, the gasket plate 150 can be moved or slid in the direction “L” along the longitudinal axis of the head frame 110, as shown, and ultimately removed from the head frame 110. A different gasket plate can then be inserted and secured within the head frame 110. Other approaches can be relied upon to secure the gasket plate 150, among others, with the head frame 110. Another example approach is described below with reference to the system 200 shown in FIGS. 8-13.

As noted above, the print window 152 of the gasket plate 150 is sized such that, when the head frame 110 is closed over the pallet 160, the print window 152 surrounds the peripheral edge of the pallet 160, with a relatively small clearance between them. The clearance can range, for example, from about ⅛″ to ½″, although other clearances can be relied upon. To partly fill or even partly obstruct that clearance, the gasket plate 150 can include the gasket strips 154A-154D. The gasket strips 154A-154D are positioned around the inner peripheral edge of the print window 152, along at least certain lengths of the inner edge. The gasket strips 154A-154D can be formed from a rubber or other deformable material and are secured in place with the gasket plate 150 by the strip ring 155, using small screws, rivets, or other suitable fasteners. When the head frame 110 is closed over the pallet 160 with a garment on the pallet 160, the gasket strips 154A-154D can help to secure and, to some extent, slightly pull or stretch the garment over the top surface of the pallet 160. In some cases, the gasket strips 154A-154D and strip ring 155 can be omitted.

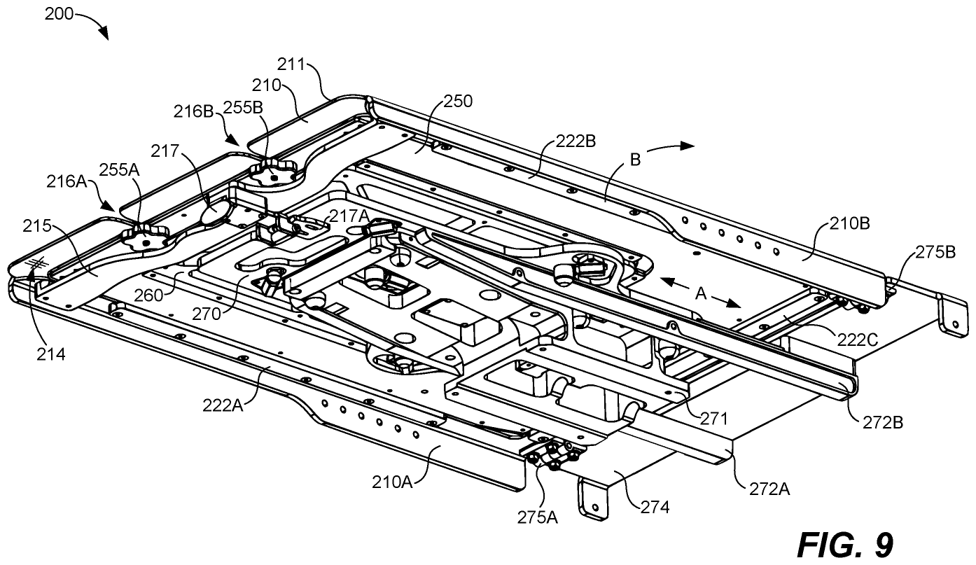

FIG. 8 illustrates a top perspective view of an example universal hold down pallet system 200 (“system 200”) in a closed position, and FIG. 9 illustrates a bottom perspective view of the system 200 shown in FIG. 8 according to various embodiments described herein. The system 200 is illustrated as a representative example in FIGS. 8 and 9. The illustrations are not drawn to any particular scale, and the sizes and shapes of the components of the system 200, as described below, can vary as compared to that shown. The illustrations are not exhaustive, and other parts or components can be included and relied upon in some cases. Additionally, one or more of the parts or components shown can be omitted in some cases. The system 200 can be formed or embodied in any suitable materials, including metals, plastics, rubbers, etc., and combinations thereof. As one example, system 100 can be formed from a combination of aluminum, plastic, and rubber, although other suitable materials can be relied upon.

Referring between FIGS. 8 and 9, the universal hold down pallet system 200 includes a head frame 210, a gasket plate 250, a pallet 260, a pallet mounting plate 270, a pedestal mount 271, pedestal rails 272A and 272B, a head frame mount 274, and a hinge assembly including hinges 275A and 275B, among other components. The head frame 210 includes a top surface 212, a bottom surface 214, a first turn-down support rail 210A, a second turn-down support rail 210B, a frame opening, a crossbar 215 with head latch assembly 217, guide channels 222A and 222B secured to the bottom surface 214 of the head frame 210, and a backstop channel 222C secured to the bottom surface 214 of the head frame 210.

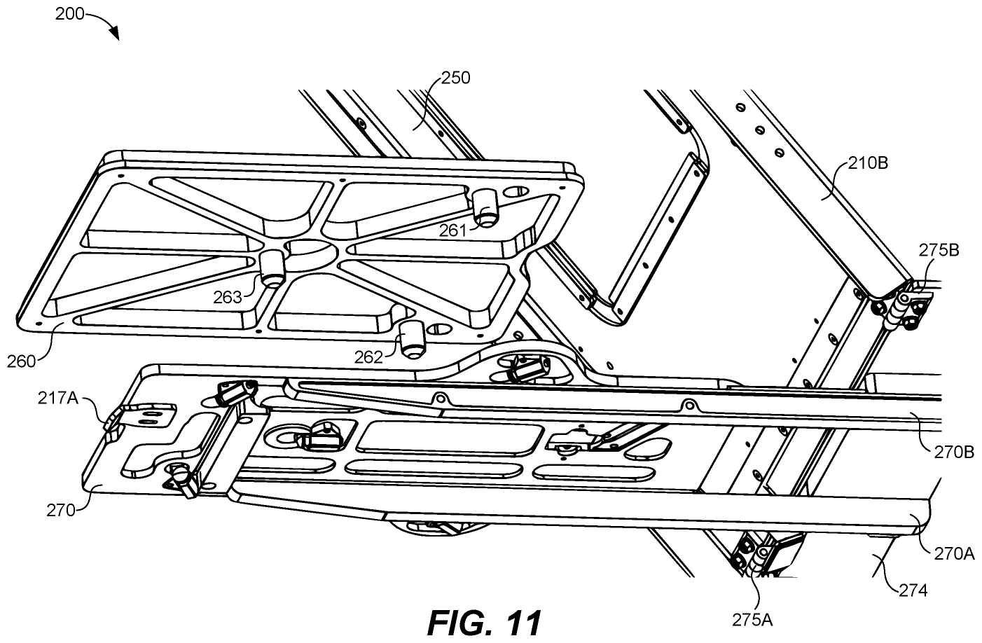

The head latch assembly 217 includes a spring-biased interlock, for interference with a latch hook 217A. The latch hook 217A is mounted to an underside of the pallet mounting plate 270, as also shown in FIGS. 10 and 11. When the head frame 210 is closed as shown in FIGS. 8 and 9, a latch arm of the head latch assembly 217 extends over and around the end of the latch hook 217A, and the head latch assembly 217 and latch hook 217A mechanically interfere with each other. In this arrangement, the head frame 210 cannot be opened or lifted up, unless the front handle of the head latch assembly 217 is pulled forward, to overcome the spring bias of the head latch assembly 217. When pulled forward, the latch arm of the head latch assembly 217 is also pulled forward, to release the mechanical interference with the latch hook 217A. In that configuration, the head frame 210 can be lifted up to the open position shown in FIG. 10. The head latch assembly 217 and latch hook 217A are provided as an example means to lock the system 200 in the closed position for printing. Other means can be used lock the system 200 in the closed position. Additionally, the system 100 can also include a similar type of head latch assembly and latch hook in some cases.

In the example shown, the pallet mounting plate 270 acts as a supporting platform for the pallet 260, and the pallet 260 can be secured on the pallet mounting plate 270 as described below. The pallet mounting plate 270 is secured to and supported by the pedestal rails 272A and 272B. In some cases, the pallet mounting plate 270 can be slidably supported by the pedestal rails 272A and 272B, such that the pallet mounting plate 270 can slide in the direction “A” shown in FIG. 9. To provide a slidable coupling between the pallet mounting plate 270 and the pedestal rails 272A and 272B, channels can be milled or otherwise formed into the bottom surface of the pallet mounting plate 270. Corresponding or mating channel interlock features can be milled or otherwise formed into the top surfaces of the pedestal rails 272A and 272B. The channel interlock features of the pedestal rails 272A and 272B can be inserted and slid into the channels of the pallet mounting plate 270.

The pedestal rails 272A and 272B are supported on opposite sides of the pedestal mount 271 using screws, bolts, or other suitable fasteners. The pedestal mount 271 positioned between the pedestal rails 272A and 272B, toward the front end of the pedestal rails 272A and 272B. The head frame mount 274 is mounted over the pedestal rails 272A and 272B, toward the back end of the pedestal rails 272A and 272B.

The pallet 260 can be removably mounted to the pallet mounting plate 270, so that the pallet 260 is interchangeable for the system 200. As described herein, both the gasket plate 250 and the pallet 260 are interchangeable, providing flexibility for operators. For example, to adapt a printing machine for use with a pallet having a different size, the system 200 allows an operator to interchange the pallet 260 and the gasket plate 250, without any need to remove the head frame 210 or other components from the printing machine.

The pallet 260 can be removably mounted to the pallet mounting plate 270 using a number of different techniques, with a preference for techniques that permit easy removal and replacement of the pallet 260 from the pallet mounting plate 270. As examples, an operator can exchange the pallet 260 with a different pallet having top surface dimensions of 4″×18″ for sleeve printing, 7.5″×7.5″ for athletic shorts, 12″×16″ for youth-large jackets, or 16″×16″ for large or extra-large jackets. The use of other pallets with other top surface dimensions, shapes, and styles are also within the scope of the embodiments. The operator can also change the gasket plate 250 by sliding it out from the head frame 210 and replacing it with a different gasket plate having a print window of a different size, to correspond to the different pallet being used, as described herein. Overall, the system 200 is not limited to the use of pallets of any particular size, shape, or configuration. Instead, the system 200 is designed to be flexible and capable of use with pallets of nearly any size and shape.

The head frame mount 274 is mounted over the pedestal rails 272A and 272B, toward the back end of the pedestal rails 272A and 272B. The head frame mount 274 can be secured to the pedestal rails 272A and 272B using any suitable mechanical or other fastening means, such as screws, bolts, welds, rivets, mechanical interferences, combinations thereof, or other means. In some cases, a mounting offset or interposer of a certain thickness can be inserted between the head frame mount 274 and the pedestal rails 272A and 272B, to ensure that the top surface of the pallet 260 is substantially coplanar with the top surface 212 of the head frame 210 when the head frame 210 is closed as shown in FIG. 8.

The head frame 210 is pivotably secured to the head frame mount 274 by a hinge assembly including the hinges 275A and 275B, which are shown in FIG. 9. The hinges 275A and 275B are illustrated as a representative example in FIG. 9, and other types of hinges and pivoting assemblies can be used to secure the trailing edge or end of the head frame 210 to the leading edge or end of the head frame mount 274. In this hinged arrangement, the leading edge 211 of the head frame 210 can pivot and rotate up in the direction “B”, as shown in FIG. 9, to pivot the head frame 210 up and apart from the pallet 260. FIG. 10 illustrates an example of the system 200 with the head frame 210 pivoted to an open position with respect to the pallet 260, and FIG. 10 is described in additional detail below.

Referring again to FIG. 9, the gasket plate 250 is secured within the head frame 210 between the guide channels 222A and 222B and the backstop channel 222C. Each of the guide channels 222A and 222B and the backstop channel 222C is formed to have an “L” shape profile. When secured to the bottom surface 214 of the head frame 210, a clearance exists between the channels 222A, 222B and 222C and the bottom surface 214 of the head frame 210. The gasket plate 250 is relatively thin (or relatively thin at its outer peripheral edges) and can slide into this clearance. Particularly, the gasket plate 250 can slide into the clearance, confined between the channels 222A and 222B and the bottom surface 214 of the head frame 210, until it contacts and stops against the backstop channel 222C.

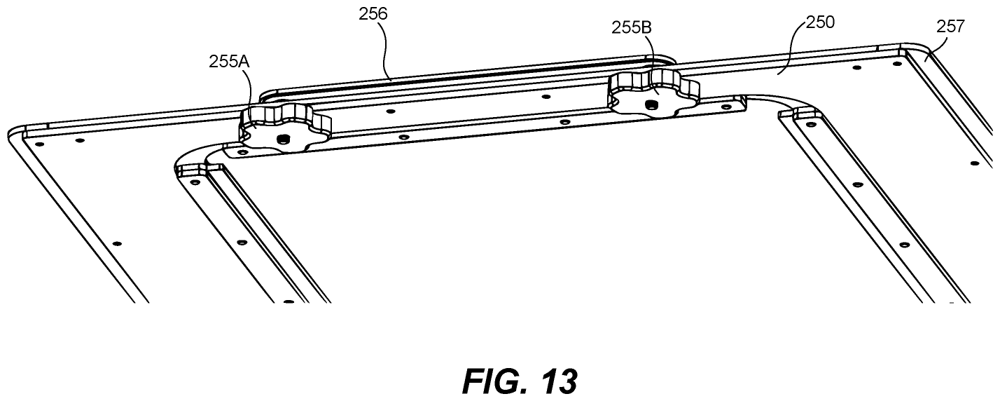

The gasket plate 250 also includes clamp adjustment knobs 255A and 255B on the bottom side, as shown in FIG. 9, and a clamp strap 256 at the top side, as shown in FIG. 8. The adjustment knobs 255A and 255B and clamp strap 256 are provided as another example of a releasable interlock capable of securing and releasing a gasket plate from a head frame according to the embodiments. The clamp adjustment knobs 255A and 255B include threaded posts that are coupled to the clamp strap 256. Rotation of the clamp adjustment knobs 255A and 255B in one direction (e.g., clockwise) will compress the clamp strap 256 against the top of the gasket plate 250. Alternatively, rotation of the clamp adjustment knobs 255A and 255B in another direction (e.g., counter-clockwise) will add a clearance between the clamp strap 256 and the top of the gasket plate 250. With the clearance between the clamp strap 256 and the top of the gasket plate 250, the threaded posts of the clamp adjustment knobs 255A and 255B can slide into the guide slots 216A and 216B at the leading edge 211 of the head frame 210 as the gasket plate 250 is inserted into the head frame 210, with the clamp strap 256 positioned over the top surface 212 of the head frame 210. Once so positioned, the clamp adjustment knobs 255A and 255B can be rotated to compress the clamp strap 256 against the top surface 212 of the head frame 210, securing the gasket plate 250 in place. Thus, using the clamp adjustment knobs 255A and 255B, the gasket plate 250 can be easily secured and removed in the system 200. Additional details related to the insertion, removal, and replacement of the gasket plate 250 in the system 200 are described below with reference to FIG. 13.

FIG. 10 illustrates the system 200 shown in FIGS. 8 and 9, with the head frame 210 pivoted to an open position. The pallet 260 is omitted from view in FIG. 10, so that other features of the system 200 can be shown. The installation of the pallet 260 is shown in FIG. 11, which is also described below. In the open position shown in FIG. 10 (and with the pallet 260 installed), a garment can be placed over the pallet 260. The head frame 210 can be biased or maintained in the open position shown in FIG. 10 using a spring, elastic band, or other biasing means 218 secured between the support rail 210B and a support clip 265 of the head frame mount 274. A similar spring, elastic band, or other biasing means can also be secured between the support rail 210A and a support clip on the other side of the head frame mount 274. The biasing means 218 can be sufficient to maintain the head frame 210 in the open position shown, against the weight of the head frame 210, unless pushed back down to the closed position shown in FIG. 8. The biasing means 218 is shown as a representative example in FIG. 10, and the biasing means 218 can be secured to other locations along the support rail 210B.

The top surface of the pallet mounting plate 270 is shown in FIG. 10. The pallet mounting plate 270 includes a number of apertures 290-294, among possibly others, that extend through the pallet mounting plate 270. The apertures 290-294 can be positioned or located at other positions through the pallet mounting plate 270, and a greater or fewer number of apertures 290-294 can be relied upon as compared to that shown. The pallet 260 includes a number of mounting posts that fit and extend through the apertures 290-294, to position and hold the pallet 260 in place over the pallet mounting plate 270. A number of rare positioned under the pallet mounting plate 270. The plungers apply pressure to the posts of the pallet 260, to help maintain it in place. Examples of the plungers are described below with reference to FIG. 11.

To print on a garment, such as a shirt, the shirt can be placed over the pallet 260, with the pallet 260 positioned as the torso of an individual would fit into the shirt, as one example. Once the shirt is positioned over the pallet 260, the head frame 210 can be pivoted back down to the closed position shown in FIGS. 8 and 9. In that way, the head frame 210 will help to hold and secure the shirt against the pallet 260. Particularly, the gasket plate 250 includes a print window 252, as shown in FIG. 10. The print window 252 is sized such that, when the head frame 210 is closed, the print window 252 surrounds the peripheral edge of the pallet 260, with a relatively small clearance between them. The clearance can range, for example, from about ⅛″ to ½″, although other clearances can be relied upon. As examples, the print window 252 of the gasket plate 250 can be sized for 4″×18″, 7.5″×7.5″, 12″×16″, 16″×16″, or other top surface areas of the pallet 260 and other pallets, with additional room for a clearance around the peripheral edges the pallets as needed. In any case, a range of different gasket plates having print windows of various sizes, with corresponding pallets having top surface regions of various sizes, can be used with the system 200.

FIG. 11 illustrates the system 200 shown in FIGS. 8 and 9 in an open position with the pallet 260. The pallet 260 includes mounting posts 261-263, among possibly others, which extend down from the bottom surface of the pallet 260. The mounting posts 261-263 can fit through the apertures 290-292 of the pallet mounting plate 270 (see FIG. 10), to secure the pallet 260 over the pallet mounting plate 270. From the position shown in FIG. 11, the pallet 260 can be aligned so that the mounting posts 261-263 align with and fit through the apertures 290-292, and the pallet 260 can be lowered down on the pallet mounting plate 270 until the bottom surface of the pallet 260 rests upon the top surface of the pallet mounting plate 270.

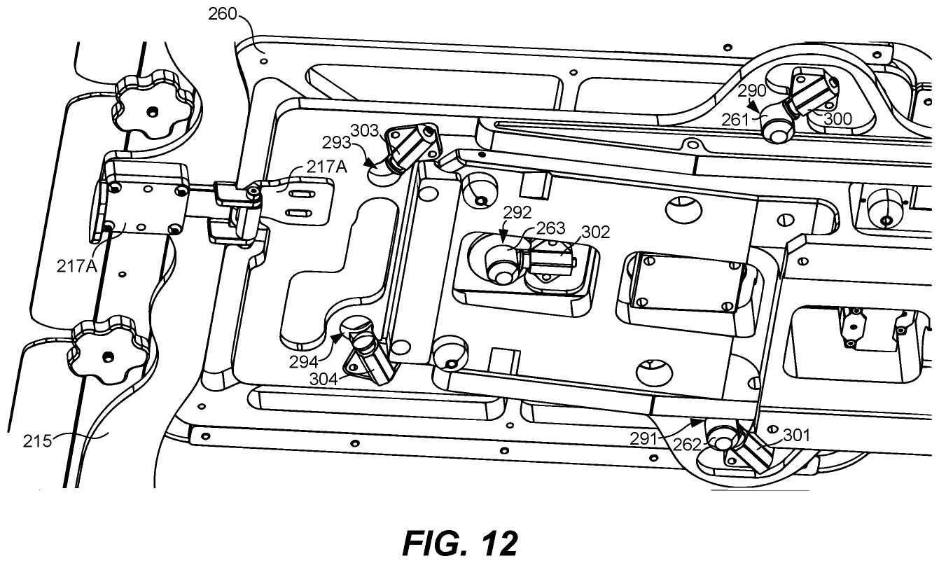

FIG. 12 illustrates the system 200 with the pallet 260 installed over the pallet mounting plate 270. Particularly, FIG. 12 illustrates the mounting posts 261-263 of the pallet 260 extending through the apertures 290-292 of the pallet mounting plate 270. The apertures 293 and 294 of the pallet mounting plate 270 are not occupied by mounting posts of the pallet 260, as the pallet 260 does not include mounting posts to extend through the apertures 293 and 294. Other pallets can include a different arrangement of mounting posts, and any group or set of the apertures 290-294 can be used depending on the size and shape of the pallet being used, among other considerations.

The pallet mounting plate 270 includes the spring-biased interference plungers 300-304, which are mounted to the bottom surface of the pallet mounting plate 270. When the mounting posts 261-263 extend through the apertures 290-292, the plungers 300-302 apply pressure along the sides of the mounting posts 261-263. This pressure is sufficient to securely hold the pallet 260 in place over the pallet mounting plate 270, although the pallet 260 can be removed (i.e., lifted) back off of the pallet mounting plate 270 with the application of sufficient upward force. Thus, the mounting posts 261-263 of the pallet 260, the apertures 290-294 of the pallet mounting plate 270, and the plungers 300-304 provide a solution for releasably securing the pallet 260 in the system 200.

FIG. 13 illustrates the end of the gasket plate 250. As shown, the gasket plate 250 includes clamp adjustment knobs 255A and 255B on the bottom side, and a clamp strap 256 at the top side. The clamp adjustment knobs 255A and 255B include threaded posts that are coupled to the clamp strap 256. Rotation of the clamp adjustment knobs 255A and 255B in one direction (e.g., clockwise) will compress the clamp strap 256 against the top of the gasket plate 250. Alternatively, rotation of the clamp adjustment knobs 255A and 255B in another direction (e.g., counter-clockwise) will add a clearance between the clamp strap 256 and the top of the gasket plate 250. With the clearance between the clamp strap 256 and the top of the gasket plate 250, the threaded posts of the clamp adjustment knobs 255A and 255B can slide into the guide slots 216A and 216B at the leading edge 211 of the head frame 210 (see FIG. 8) as the gasket plate 250 is inserted into the head frame 210, with the clamp strap 256 positioned over the top surface 212 of the head frame 210. Once so positioned, the clamp adjustment knobs 255A and 255B can be rotated to compress the clamp strap 256 against the top surface 212 of the head frame 210, securing the gasket plate 250 in place. Thus, using the clamp adjustment knobs 255A and 255B, the gasket plate 250 can be easily secured and removed in the system 200.

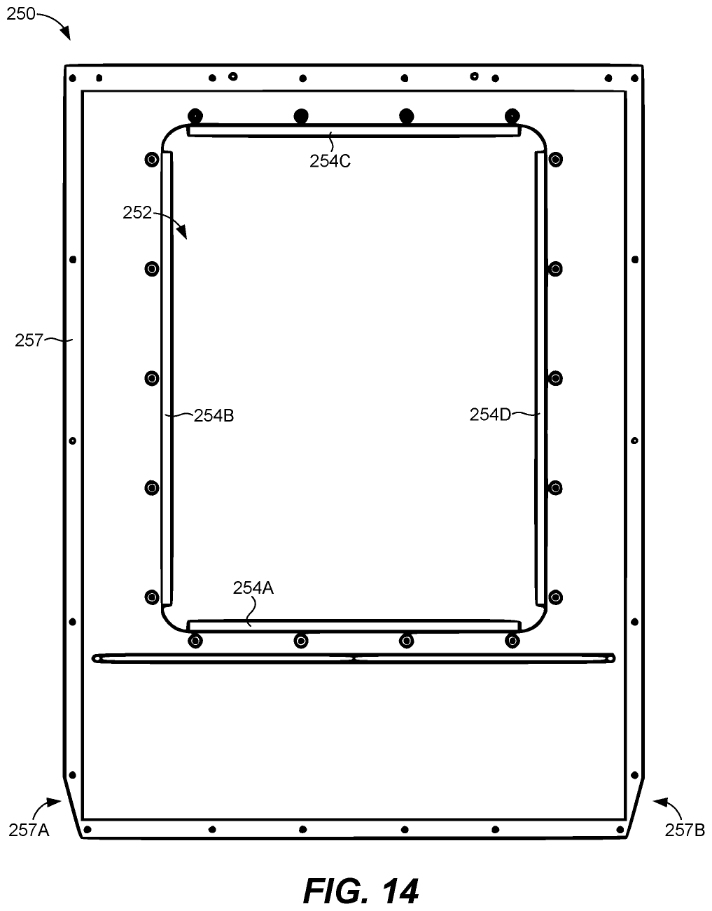

FIG. 14 illustrates a top view of the gasket plate 250 that can be used with the system 200 shown in FIGS. 8 and 9 according to various embodiments described herein. The gasket plate 250 is shown as a representative example in FIG. 14, and other gasket plates can be used with the system 200, just as other pallets similar to the pallet 260 can be used. Other gasket plates can include print windows of different sizes, positions, and shapes as compared to the print window 252, for use with other pallets of different sizes and shapes according to the concepts described herein.

In some cases, the gasket plate 150 can be marked to identify the size of the print window 252 using a stamp, milling or engraving, a sticker, or other means. The size of the print window can be identified using specific dimensions of the print window 252 or using a numbering system corresponding to certain sizes. The gasket plate 150, and other gasket plates according to the concepts described herein, can be marked to identify other features related to the gasket plates. Similarly, the pallet 260 can be marked to identify the size of the top surface of the pallet 260 using a stamp, milling or engraving, a sticker, or other means. The size of the top surface can be identified using specific dimensions or using a numbering system corresponding to certain sizes. The pallet 260, and other pallets according to the concepts described herein, can be marked to identify other features related to the pallets.

As shown in FIG. 13, the print window 252 of the gasket plate 250 is sized for use with the pallet 260 such that, when the head frame 210 is closed over the pallet 260, the print window 252 surrounds the peripheral edge of the pallet 260, with a relatively small clearance between them. The clearance can range, for example, from about ⅛″ to ½″, although other clearances can be relied upon. To partly fill or even partly obstruct that clearance, the gasket plate 250 can include the gasket strips 254A-254D. The gasket strips 254A-254D are positioned around the inner peripheral edge of the print window 252, along at least certain lengths of the inner edge. The gasket strips 254A-254D can be formed from a rubber or other deformable material and can be secured in place by a strip ring (not shown in FIG. 13, see example strip ring 155 in FIG. 7), using small screws, rivets, or other suitable fasteners. When the head frame 210 is closed over the pallet 260 with a garment on the pallet 260, the gasket strips 254A-254D can help to secure and, to some extent, slightly pull or stretch the garment over the top surface of the pallet 260. In some cases, the gasket strips 254A-254D can be omitted.

The gasket plate 250 also includes a thinned peripheral edge 257 (see also FIG. 13) in the example shown. The thinned peripheral edge 257 can extend around one or more sides of the gasket plate 250 and is sized to fit within the clearance between the channels 222A, 222B and 222C and the bottom surface 214 of the head frame 210. In other cases, the gasket plate 250 can be manufactured without the thinned peripheral edge 257. The gasket plate 250 also includes tapered corners 257A and 257B, at one end. The tapered corners 257A and 257B can help to guide the gasket plate 250 into the channels 222A, 222B and 222C, as it is being installed with the head frame 210.

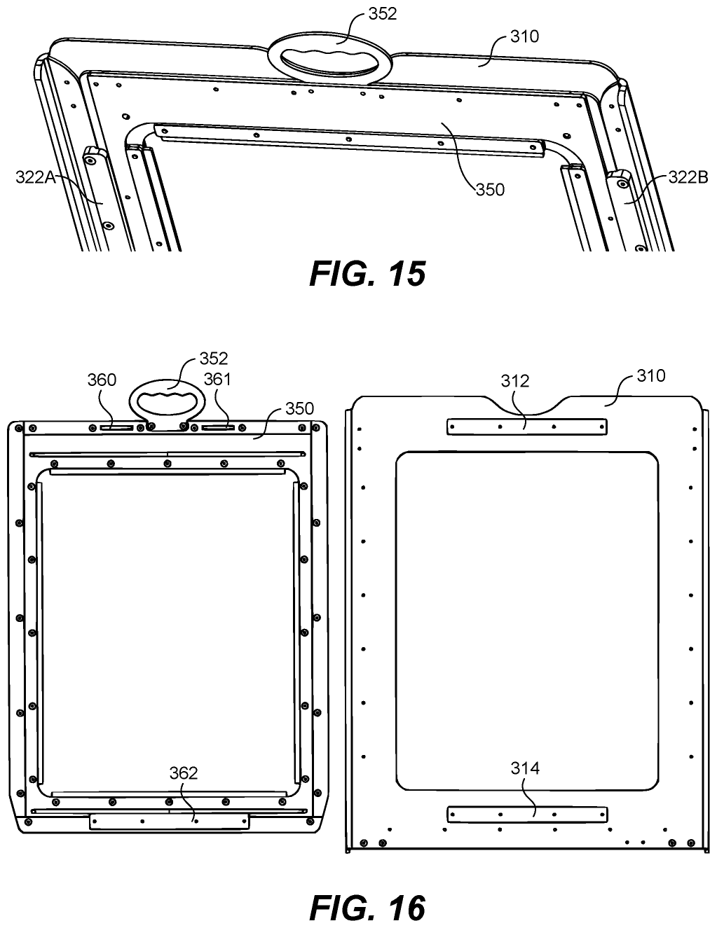

FIG. 15 illustrates another example gasket plate 350 and head frame 310 that can be used with a universal hold down pallet system according to the concepts described herein. The gasket plate 350 and head frame 310 incorporate a different type of releasable interlock for securing and releasing the gasket plate 350 from the head frame 310. As shown in FIG. 15, the gasket plate 350 includes a handle 352 at one end. The gasket plate 350 can slide into the guide channels 322A and 322B, which are secured to the bottom surface of the head frame 310, similar to the concepts described above. However, the gasket plate 350 does not include or rely upon the clamp adjustment knobs 255A and 255B and the clamp strap 256 of the gasket plate 250 to secure it in place. Instead, the gasket plate 350 and the head frame 310 include magnets for that purpose. The magnets can be embodied as any suitable type of magnets, including ceramic, ferrite, neodymium, samarium cobalt, or other magnets.

FIG. 16 separately illustrates the gasket plate 350 and head frame 310 shown in FIG. 15, side-by-side. As shown, the gasket plate 350 includes magnets 360-362. The head frame 310 also includes magnets 312 and 314. The number and positions of the magnets 312, 314, and 360-362 can vary as compared to that shown. The magnets 312, 314, and 360-362 can also be positioned on outer surfaces (e.g., top or bottom surfaces) of the gasket plate 350 and head frame 310 using adhesives, mechanical fasteners (i.e., screws, bolts, rivets, pins, etc.), integrated with or through the surfaces of gasket plate 350 and the head frame 310, or integrated in other ways.

The magnets on the gasket plate 350 are preferably positioned to align with the magnets on the head frame 310 when the gasket plate 350 is fully inserted into the head frame 310. In the example shown, when the gasket plate 350 is fully inserted into the head frame 310, the magnets 360 and 361 on the gasket plate 350 are positioned for alignment with the magnet 312 on the head frame 210. Also, the magnet 362 on the gasket plate 350 is positioned for alignment with the magnet 314 on the head frame 210. When the gasket plate 350 is inserted into the head frame 310, the magnets 360-362 on the gasket plate 350 will be attracted and secure to the magnets 312 and 314 on the head frame 310, securing the gasket plate 350 into position with the head frame 310. The magnetic attraction between the magnets 312, 314, and 360-362 can be overcome by a pulling force applied to the handle 352 of the gasket plate 350, to remove the gasket plate 350 from the head frame 310.

The gasket plate 350 and the head frame 310 can be formed from a non-magnetic material, such as aluminum. Thus, the magnets 312, 314, and 360-362 will be attracted to each other but not to the bodies of the gasket plate 350 or the head frame 310, permitting the gasket plate 350 to be inserted into the head frame 310 without general magnetic attraction between them.

The above-described examples of the present disclosure are merely possible examples of implementations set forth for a clear understanding of the principles of the disclosure. Many variations and modifications can be made without departing substantially from the spirit and principles of the disclosure. All such modifications and variations are intended to be included herein within the scope of this disclosure and protected by the following claims.

Therefore, the following is claimed:

1. A hold down system for printing, comprising:
a head frame comprising a gasket plate opening; and
a gasket plate for use with the head frame, the gasket plate comprising a print window sized to surround a top surface of a pallet when the head frame is closed.

2. The system according to claim 1, wherein the head frame comprises a guide channel to secure and position the gasket plate with the head frame.

3. The system according to claim 1, wherein the head frame comprises a guide slot to secure the gasket plate with the head frame.

4. The system according to claim 1, wherein the gasket plate comprises a gasket strip that extends along a length of an inner peripheral edge of the print window.

5. The system according to claim 1, wherein the gasket plate comprises a tapered corner.

6. The system according to claim 1, further comprising:
a pallet mount; and
the pallet, wherein the pallet comprises a guide channel or a mounting post for releasable installation of the pallet on the pallet mount.

7. The system according to claim 6, wherein:
the pallet mount comprises a rail slot;
the pallet comprises a guide channel; and
the guide channel of the pallet slides into the rail slot of the pallet mount to secure the pallet on the pallet mount.

8. The system according to claim 6, wherein:
the pallet mount comprises an aperture;
the pallet comprises a guide post; and
the guide post of the pallet fits into the aperture of the pallet mount to secure the pallet on the pallet mount.

9. The system according to claim 6, wherein the print window surrounds a top surface of the pallet when the head frame is closed, with a clearance between an inner peripheral edge of the print window and the top surface of the pallet.

10. The system according to claim 1, further comprising a releasable interlock for securing and releasing the gasket plate from the head frame.

11. The system according to claim 10, wherein the releasable interlock comprises a pivoting arm.

12. The system according to claim 10, wherein the releasable interlock comprises an adjustment knob and a clamp strap.

12. The system according to claim 10, wherein the releasable interlock comprises a magnet positioned on the gasket plate and a magnet positioned on the head frame.

14. A hold down system for printing, comprising:
a head frame comprising a gasket plate opening and a gasket plate guide channel secured to a bottom surface of the head frame;
a gasket plate for use with the head frame, the gasket plate comprising a print window;
a pallet mount; and
a pallet, wherein the pallet comprises a guide channel or a mounting post for releasable installation of the pallet on the pallet mount.

15. The system according to claim 14, wherein the head frame comprises a guide slot to secure the gasket plate with the head frame.

16. The system according to claim 14, wherein the gasket plate comprises a gasket strip that extends along a length of an inner peripheral edge of the print window.

17. The system according to claim 14, wherein:
the pallet mount comprises a rail slot;
the pallet comprises a guide channel; and
the guide channel of the pallet slides into the rail slot of the pallet mount to secure the pallet on the pallet mount.

18. The system according to claim 14, wherein:
the pallet mount comprises an aperture;
the pallet comprises a guide post; and
the guide post of the pallet fits into the aperture of the pallet mount to secure the pallet on the pallet mount.

19. The system according to claim 14, wherein the print window surrounds a top surface of the pallet when the head frame is closed, with a clearance between an inner peripheral edge of the print window and the top surface of the pallet.

20. The system according to claim 14, further comprising a releasable interlock for securing and releasing the gasket plate from the head frame.
